(19) United States
(12) Patent Application Publication
(10) Pub. No.: US 2010/0140036 A1
(43) Pub. Date: Jun. 10, 2010

(54) COMPACT DRY DUAL CLUTCH MODULE

(75) Inventor: Craig S. Ross, Ypsilanti, MI (US)

Correspondence Address: VIVACQUA LAW, PLLC, 455 East Eisenhower Parkway, Suite 200, ANN ARBOR, MI, 48108, US

(73) Assignee: GM GLOBAL TECHNOLOGY OPERATIONS, INC., Detroit, MI (US)

(21) Appl. No.: 12/505,965

(22) Filed: Jul. 20, 2009

Related U.S. Application Data
(60) Provisional application No. 61/120,633, filed on Dec. 8, 2008.

(51) Int. Cl. F16D 21/08

(52) U.S. Cl. 192/48.7

(57) ABSTRACT

The present invention provides a dry, dual clutch module having reduced axial length. The clutch module includes a larger diameter, single plate outer clutch which drives a first transmission input shaft or drive quill and a smaller diameter, double plate inner clutch which drives a second transmission input shaft or drive quill. The smaller diameter clutch is nested within the larger diameter clutch and thus they essentially reside within the same axial space.

### CROSS-REFERENCE TO RELATED APPLICATION

This application claims the benefit of U.S. Provisional Application No. 61/120,633, filed on Dec. 8, 2008, which is hereby incorporated in its entirety herein by reference.

### FIELD

The present disclosure relates to driveline clutches and more particularly to a dry, dual clutch module for use with a dual clutch transmission.

### BACKGROUND

The statements in this section merely provide background information related to the present disclosure and may or may not constitute prior art.

Within the motor vehicle transmission art, the dual clutch transmission (DCT) is a relative newcomer. A typical dual clutch transmission configuration includes a pair of mutually exclusively operating input clutches which drive parallel layshafts or countershafts spaced from a parallel output shaft. One of each of a plurality of pairs of constantly meshing gears, which provide the various forward gear ratios is freely rotatably disposed on one of the countershafts and the other of each pair of gears is coupled to the output shaft. A plurality of synchronizer clutches selectively couple one of the gears to a countershaft to achieve a forward gear ratio.

Dual clutch transmissions are known for their sporty, performance oriented shift characteristics. Moreover, with appropriate peripheral electronic and hydraulic components, a dual clutch transmission can function as either a manual, semi-automatic or automatic transmission. In every case, they typically exhibit good fuel economy due to their good gear mesh efficiency and ratio selection flexibility. The clutches have low spin losses which also contribute to overall operating efficiency.

Dual clutch transmissions do, however, have certain unique design considerations which present engineering challenges. For example, because of the input torque throughput during launch and the heat that can be generated with clutch slip. The input clutches must be of relatively large size. This size requirement applies as well to the thermal heat sink which must be able to absorb large quantities of heat. Additionally, because such transmissions typically have many sets of axially aligned gears, their overall length may limit their use to certain vehicle platforms.

The present invention is directed to a clutch module for a dual clutch transmission having reduced axial length which reduces the overall length of the transmission and thus provides greater flexibility of transmission application.

### SUMMARY

The present invention provides a dry, dual clutch module having reduced axial length. The dual clutch module includes a larger diameter, single plate outer clutch which drives a first transmission input shaft or drive quill and a smaller diameter, double plate inner clutch which drives a second transmission input shaft or drive quill. The smaller diameter clutch is nested within the larger diameter clutch and they thus essentially reside within the same axial space.

Thus it is an object of the present invention to provide a dual clutch module for a transmission having a short axial length.

It is a further object of the present invention to provide a dual clutch module for a transmission having inner and outer clutches.

It is a still further object of the present invention to provide a dry, dual clutch module for a dual clutch transmission.

It is a further object of the present invention to provide a dual clutch module having a single plate outer clutch and a dual plate inner clutch.

It is a still further object of the present invention to provide a dual clutch module for a dual clutch transmission having a short axial dimension and wherein an inner clutch is essentially nested within an outer clutch.

Further objects, advantages and areas of applicability of the present invention will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a full sectional view of a portion of a dual clutch transmission incorporating a dual clutch module according to the present invention;

FIG. 2 is an enlarged, full sectional view of a dual clutch module according to the present invention, and

FIG. 3 is a pictorial view in full section of a dual clutch module according to the present invention.

### DETAILED DESCRIPTION

The following description is merely exemplary in nature and is not intended to limit the present disclosure, application, or uses.

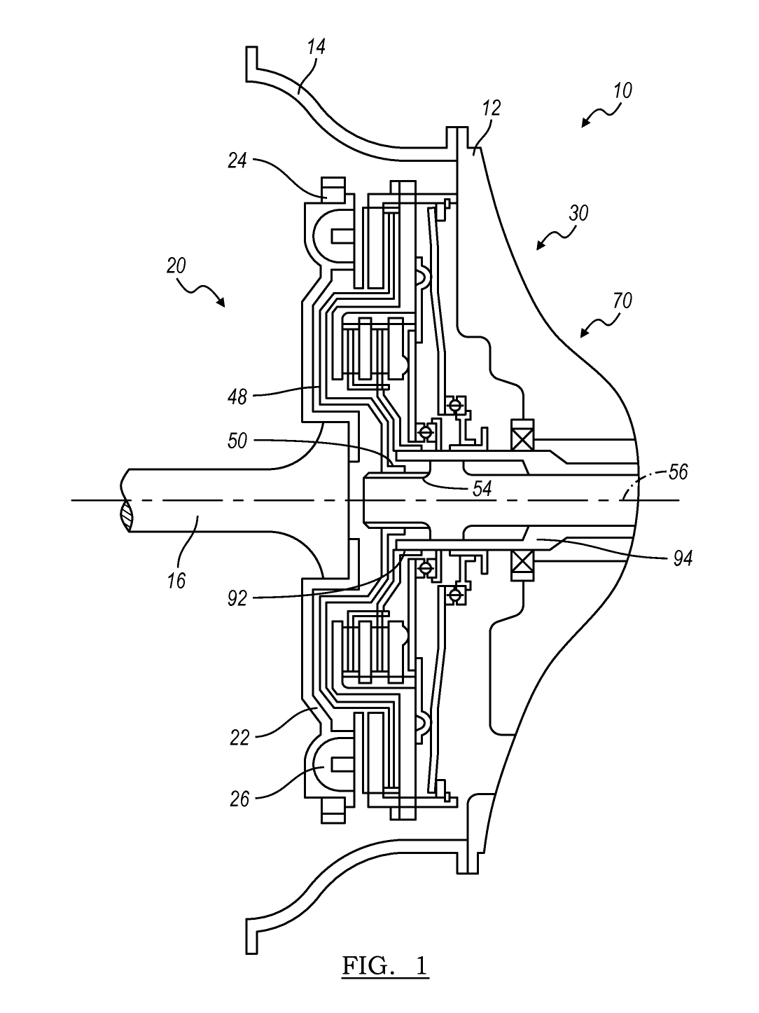

With reference to FIG. 1, a portion of a dual clutch transmission incorporating the present invention is illustrated and generally designated by the reference number 10. The transmission 10 includes a typically cast metal housing 12 having openings, flanges, bores and other machined surfaces which receive, support, locate and protect the various components of the transmission 10. A bell housing 14 which is secured to the transmission housing 12 encloses a compact dry dual clutch module 20 according to the present invention. As utilized herein, the term “dry” means that the clutch and more specifically the clutch plates operate dry, without a cooling or lubricating fluid and are thus generally mounted outside the housing 12 of the transmission 10, such as in the bell housing 14 illustrated.

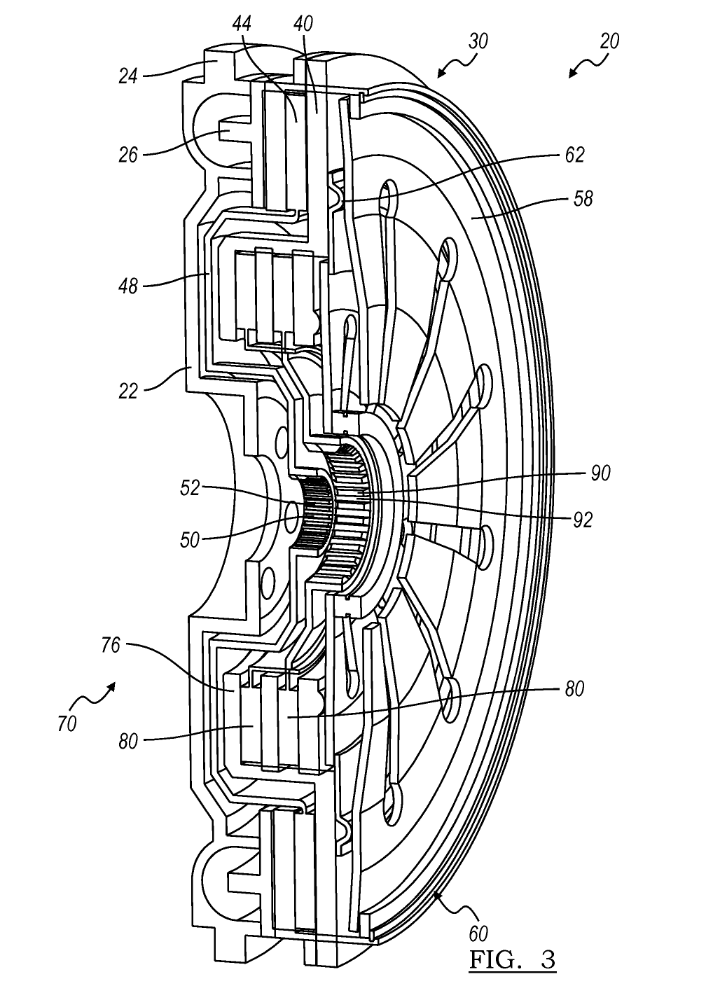

With reference now to FIGS. 1, 2 and 3, a clutch input shaft 16 receives drive torque from a prime mover (not illustrated) such as an internal combustion gasoline, Diesel or flexible fuel engine or hybrid power plant. The clutch input shaft 16 is coupled to a flywheel 22 which includes a starter ring (gear teeth) 24 about its periphery and an isolator 26. A plurality of fasteners 28 such as machine bolts secure the flywheel 22 to the clutch input shaft 16. The flywheel 22 functions as the drive member of the dual clutch module 20.

The dual clutch module 20 includes a first, outer friction clutch assembly 30 and a second, inner friction clutch assembly 70. The flywheel 22 and the isolator 26 define a flat, annular surface 32 which abuts, supports and drives a first outer clutch drive plate or disc 34. Spaced from and coupled to the first outer clutch drive plate or disc 34 by an annular collar 38 and therefore rotating with the first outer clutch drive plate 34 is a second, outer clutch drive plate or disc 40. Disposed between the first and second outer drive plates 34 and 40 is an outer driven clutch plate or disc 44 which includes suitable friction clutch facing material 46 on both faces. The driven clutch plate 44 includes a deep drawn, “top hat” portion 48 as well as a collar or hub 50 having internal splines 52 which engage external splines 54 on a transmission input shaft 56. The input shaft 56 is associated with and drives certain gears (not illustrated) within the dual clutch transmission 10 which, when engaged, provide certain gear drive ratios.

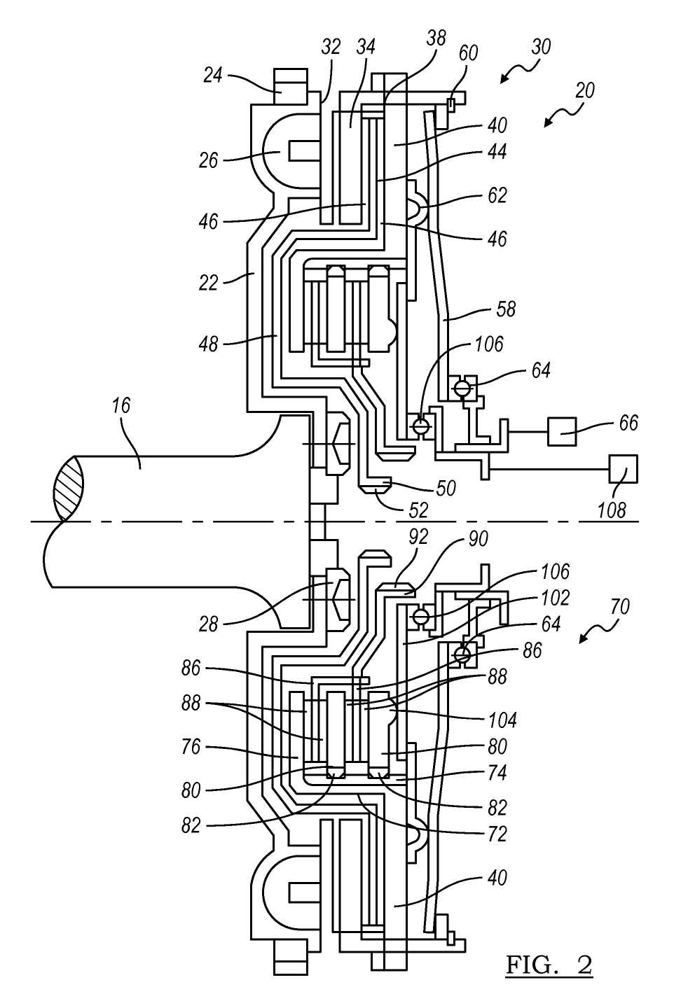

A first, outer apply plate or spring 58 which is retained within the annular collar 38 by a snap ring assembly 60 functions as a lever to actuate the first outer friction clutch assembly 30. The outer apply plate or spring 58 engages a circular pivot plate 62 radially inwardly of the snap ring assembly 60 and an first, outer thrust or apply bearing assembly 64 adjacent its inner edge. Axial force applied to the outer thrust bearing assembly 64 by a first, outer clutch actuator 66 deflects the apply plate or spring 58 to the left in FIG. 2, pivoting the spring 58 about the plate 62, pulling the first outer clutch drive plate 34 to the right, compressing the outer drive and driven clutch plates 34, 40 and 44 and achieving torque transfer from the clutch input shaft 16 to the transmission input shaft 56. The first, outer clutch actuator 66 may be a hydraulic, pneumatic or electric actuator.

Turning now to the second, inner friction clutch assembly 70, the second, outer clutch drive plate or disc 40 is also a “top hat” shape in section and includes a hub 72 having internal or female splines 74 and a radially inwardly extending stop plate 76. A pair of inner clutch drive plates or discs 80 having external or male splines 82 reside within the hub 72 and engage the female splines 74. Accordingly, the pair of inner clutch drive plates 80 rotate with the hub 72, the second, outer clutch drive plate or disc 40 and the flywheel 22. Disposed between the stop plate 76 and the adjacent inner clutch drive plate 80 and between the pair of inner clutch drive plates 80 are a pair of inner, driven clutch plates or discs 86 having suitable clutch facing material 88 on each face. The inner, driven clutch plates 86 are coupled to an inner driven clutch hub 90 which, in turn, is splined by interengaging splines 92 to a transmission input quill or drive tube 94. The input quill or drive tube 94 is associated with and drives certain other gears (not illustrated) within the dual clutch transmission 10 which, when engaged, provide other gear drive ratios and, for example, reverse.

Another lever assembly actuates the second, inner friction clutch assembly 70. An inner apply plate or spring 102 which is axially restrained at its periphery by an inward extension of the circular pivot point plate 62 or a similar structure engages a circular pivot ridge 104 on the rear face of the inner clutch drive plate 80 adjacent the inner apply plate or spring 102. An inner thrust or apply bearing assembly 106 engages the inner apply plate or spring 102 adjacent its inner edge. Axial force applied to the inner thrust or apply bearing assembly 106 by a second, inner clutch actuator 108 deflects the apply plate or spring 102 to the left in FIG. 2, pivoting the spring 102 about the ridge 104, translating the adjacent inner clutch drive plate 80 to the left, compressing the inner drive and driven clutch plates 80 and 86 and achieving torque transfer from the clutch input shaft 16 to the transmission input quill or drive tube 94.

While the axial space saving achieved by nesting the clutches 30 and 70 associated with the dual drives to the transmission 10 is a significant benefit of the present invention, it should be understood that the configuration generally necessitates an inner clutch assembly 70 having more plates or discs and thus more active clutch surface area than the outer clutch assembly 30 in order to provide comparable torque throughput and service life due to its smaller nominal diameter. Thus while the outer clutch assembly 30 has been described herein as having a single driven clutch plate or disc 44 and the inner clutch assembly 70 as having a pair of driven clutch plates or discs 86, said configuration is primarily illustrative and exemplary and different numbers of clutch plates in both clutch assemblies 30 and 70 and different ratios of the number of clutch plates (other than 1:2) are all within the purview of the present invention.

The description of the invention is merely exemplary in nature and variations that do not depart from the gist of the invention are intended to be within the scope of the invention. Such variations are not to be regarded as a departure from the spirit and scope of the invention.

What is claimed is:

1. A dual clutch assembly for a motor vehicle transmission comprising, in combination,
a first clutch having a first input member, a first clutch plate coupled to a first output member and a first clutch operator, and
a second clutch having a second input member, a pair of clutch plates coupled to a second output member and a second clutch operator,
said first clutch plate having an inside diameter larger than an outside diameter of said pair of clutch plates, whereby said second clutch is nested in said first clutch.

2. The dual clutch assembly of claim 1 further including thrust bearings operably disposed between said operators and said plates.

3. The dual clutch assembly of claim 1 wherein said first input member and said second input member are a common flywheel driven by a shaft.

4. The dual clutch assembly of claim 1 wherein said first output member is a shaft and said second output member is tubular.

5. The dual clutch assembly of claim 1 further including splined interconnections between said clutch plates and said output members.

6. The dual clutch assembly of claim 1 wherein said clutch plates include friction facing material.

7. The dual clutch assembly of claim 1 further including apply plates operably disposed between said clutch operators and said clutch plates.

8. A dual clutch module for motor vehicle power trains comprising, in combination,
a first, outer clutch assembly including a first pair of spaced-apart drive plates, a first driven plate disposed between said first pair of drive plates, a first clutch operator and a first apply plate operably disposed between said first operator and one of said pair of spaced-apart drive plates, and
a second, inner clutch assembly including a plurality of spaced-apart drive plates, at least a pair of driven plates interleaved with said plurality of drive plates, a second clutch operator and a second apply plate operably disposed between said second operator and one of said plurality of drive plates,
whereby said second, inner clutch is nested within said first, outer clutch.

9. The dual clutch module of claim 8 further including a flywheel driving said first pair of drive plates and said plurality of drive plates.

10. The dual clutch module of claim 8 further including a flywheel coupled to said first pair of drive plates and said plurality of drive plates and a drive shaft coupled to said flywheel.

11. The dual clutch module of claim 8 further including thrust bearings operably disposed between said clutch operators and said apply plates.

12. The dual clutch module of claim 8 further including first and second output members coupled to said first and said pair of driven plates, respectively.

13. The dual clutch module of claim 8 further including an output shaft coupled to said first driven plate and an output quill coupled to said pair of driven plates.

14. A dual clutch module for a motor vehicle transmission comprising, in combination,
an outer clutch assembly including a pair of spaced-apart outer drive plates, an outer driven plate disposed between said pair of outer drive plates, an outer clutch operator and an outer apply plate operably disposed between said outer operator and one of said pair of spaced-apart outer drive plates, and
an inner clutch assembly including a plurality of spaced-apart inner drive plates, at least a pair of inner driven plates interleaved with said plurality of outer drive plates, an inner clutch operator and an inner apply plate operably disposed between said inner operator and one of said plurality of inner drive plates,
whereby said inner clutch is nested within said outer clutch.

15. The dual clutch module of claim 14 including friction facing material on said clutch plates.

16. The dual clutch module of claim 14 further including a flywheel driving said outer pair of drive plates and said plurality of inner drive plates.

17. The dual clutch module of claim 14 further including a flywheel coupled to said outer pair of drive plates and said plurality of inner drive plates and a drive shaft coupled to said flywheel.

18. The dual clutch module of claim 14 further including thrust bearings operably disposed between said clutch operators and said apply plates.

19. The dual clutch module of claim 14 further including output members coupled to said outer driven plate and said pair of driven plates.

20. The dual clutch module of claim 14 further including an output shaft coupled to said outer driven plate and an output quill coupled to said pair of inner driven plates.
